(19) United States
(12) Patent Application Publication
(10) Pub. No.: US 2025/0030636 A1
(43) Pub. Date: Jan. 23, 2025

(54) RULE LOOKUP FOR PROCESSING PACKETS

(71) Applicant: Intel Corporation, Santa Clara, CA (US)

(72) Inventors: Doron NAKAR, Shoham (IL); Anurag AGRAWAL, Santa Clara, CA (US)

(21) Appl. No.: 18/900,700

(22) Filed: Sep. 28, 2024

(51) Int. Cl. H04L 45/748; H04L 45/42

(52) U.S. Cl. CPC H04L 45/748; H04L 45/42

(57) ABSTRACT

Examples described herein relate to configuring a device to perform longest prefix match (LPM) of rules associated with nodes to identify an action to perform on a packet. The rules can be stored among a memory and ternary content-addressable memory (TCAM) based on available memory capacity of the TCAM.

### BACKGROUND

Data centers provide vast processing, storage, and networking resources to users. For example, automobiles, smart phones, laptops, tablet computers, or internet of things (IoT) devices can leverage data centers to perform data analysis, data storage, or data retrieval. Data centers are typically connected together using high speed networking devices such as network interfaces, switches, or routers.

To process packets, network interface devices (e.g., switches, routers, network interface controllers, infrastructure processing units (IPU), or data processing units (DPUs)) identify and apply an entry from a routing table by searching for a match for a longest matching input string. Longest prefix match (LPM) identifies matching table entries with the longest subnet mask. For example, LPM can identify an entry with a largest number of leading address bits of the destination Internet Protocol (IP) address that match those in the table entry.

### BRIEF DESCRIPTION OF THE DRAWINGS

FIG. 1 depicts an example system.

FIGS. 2A-2D depicts an example operation.

FIGS. 3A-3C depicts an example code segment.

FIGS. 4A and 4B depict example processes.

FIG. 5 depicts an example network interface device.

FIGS. 6A-6B depict example network interface devices.

FIG. 7 depicts an example system.

### DETAILED DESCRIPTION

Entries can be associated with nodes of a Trie (trie) data structure. A trie (or digital trie or prefix trie) data structure allows strings with similar character prefixes to use the same prefix data and store other characters as separate data. A character or sequence of the value (e.g., strings, values, addresses, or multiple bits) can be associated with each node level of a tree, with the first character or bit pattern associated with a root node. Child nodes emanating from a parent node are associated with a specific character string or bit pattern. A trie lookup is performed K bits at a time from the most significant bits (MSB) down to least significant bits (LSB). Hence, a node is compared to the K bits input by masks or partial masks.

For a larger numbers of prefixes (e.g., a mix of 1 bit (1b), 2 bit (2b), or 32b prefix lengths) or sparse rules that do not share prefixes or MSBs, the amount of memory used to store entries can expand beyond available memory for trie nodes, and for solutions, such as ternary content-addressable memory (TCAM), and the memory is not able to store the entries. A TCAM can store bits of data and a state for bits (e.g., “x” or “don't care”) so that the TCAM can perform searches for data bits by ignoring specific bits.

At least to reduce memory usage to store rules of a Trie node and to reduce time of a network forwarding device (e.g., switch, router, or other network interface device) to complete LPM operations to identify a rule match and associated action or no rule match and associated action, various examples utilize a TCAM to store rules associated with one or more nodes, but where the TCAM has insufficient memory space to store rules of a trie, TCAM can store rules associated with at least the lowest level node and the volatile memory can store rules associated with other higher level nodes, including the root node.

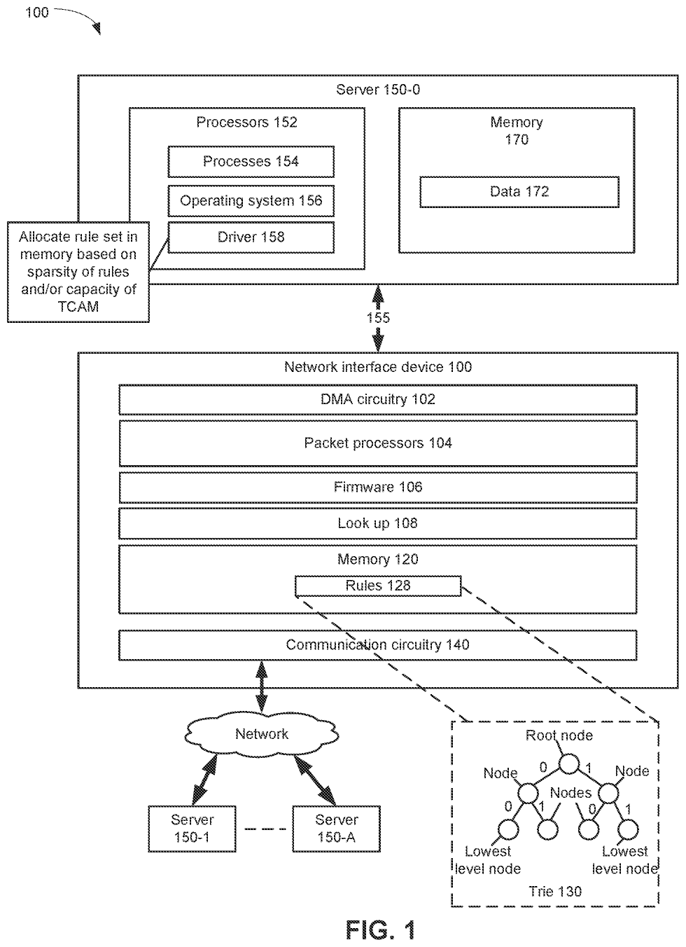

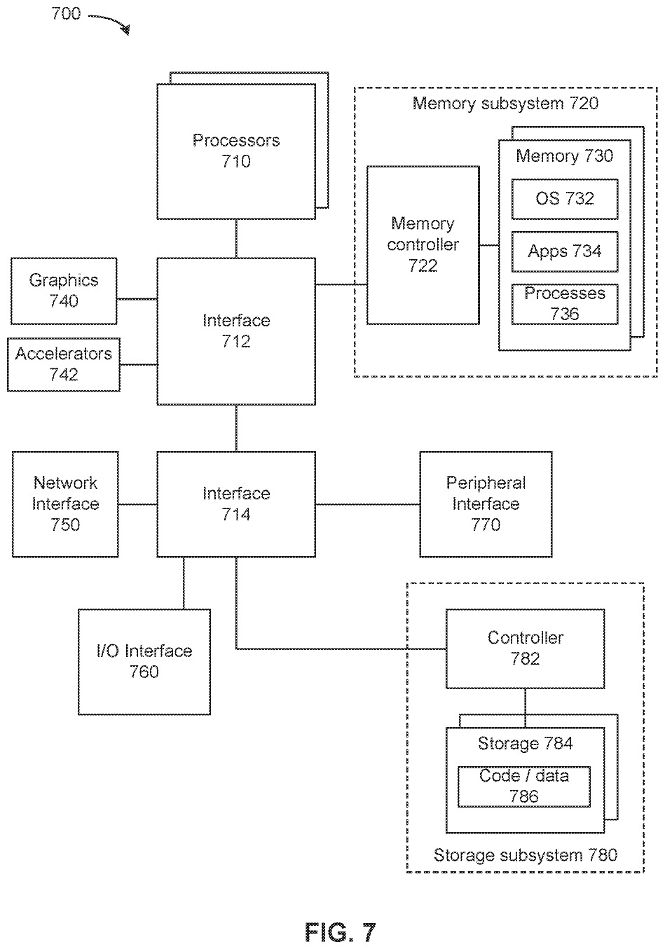

FIG. 1 depicts an example system. One or more of servers 150-0 to 150-A can include processors 152, memory 160, and other circuitry and/or software described herein at least with respect to the system of FIG. 7. In some examples, one or more of servers 150-0 to 150-A can be implemented as an SoC or one or more tiles. An SoC can include an integrated circuit that includes one or more of: one or more processors, memory interface, input/output (I/O) circuitry, storage interface, network interface, and other circuitry. A tile can include one or more processors and I/O circuitry formed in an SoC or connected by a circuit board.

Processors 152 can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry.

Processors 152 can execute processes 154. Processes 154 can include one or more of: application, process, thread, a virtual machine (VM), microVM, container, microservice, or other virtualized execution environment. Processes 154 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Processes 154 can perform operations associated with artificial intelligence (AI) or machine learning (ML) operations such as collective operations or operations of a kernel.

Processors 152 can include a system agent or uncore (not shown) that can include or more of a memory controller, a shared cache (e.g., last level cache (LLC)), a cache coherency manager, arithmetic logic units, floating point units, core or processor interconnects, Caching/Home Agent (CHA), interface circuitry (e.g., fabric, memory, device), and/or bus or link controllers. A system agent or uncore can provide one or more of: direct memory access (DMA) engine connection, non-cached coherent master connection, data cache coherency between cores and arbitrates cache requests, or Advanced Microcontroller Bus Architecture (AMBA) capabilities.

Processors 152 can execute operating system (OS) 156 and/or driver 158. For example, OS 156 or driver 158 can be consistent with a Linux operating system. In some examples, OS 156 or driver 158 can call an application programming interface (API) to configure a set of rules 128 to apply to packets to be transmitted by network interface device 100 or packets that were received by network interface device 100. A rule can specify an action of one or more of: forward to particular destination Internet Protocol (IP) address (e.g., Internet Protocol version 4 (IPv4), IPv6, or other versions), forward to a particular process (e.g., VM, container, or other), drop, modify particular packet header field, trigger an exception or error notice, indicate a denial of service (DOS) attack and drop the packet, indicate how a packet is processed or forwarded, indicate cryptographic operations to perform on the packet, perform access control, determine packet priority, determine offload circuitry or microservice operations to apply, or others.

Memory 120 can include one or more of: a TCAM, one or more registers, one or more cache devices (e.g., level 1 cache (L1), level 2 cache (L2), level 3 cache (L3), last level cache (LLC)), volatile memory device, non-volatile memory device, or persistent memory device. For example, memory 120 can include static random access memory (SRAM) memory technology or memory technology consistent with high bandwidth memory (HBM), or double data rate (DDR), among others.

In some examples, firmware 106, OS 156 and/or driver 158 can store rules 128 to be searched by network interface device 100 using nodes of a trie data structure in TCAM, registers, and cache or RAM of memory 120, as described herein. Matching with a trie node can be determined based on a match of one or more priority ordered K bit data vectors with a bit length mask. A TCAM can be used to store nodes for comparison of different length size inputs, configurable either per node or per entry (e.g., rule).

One or more rules of rules 128 can be associated with a node of a trie. An example rule and action to be applied to a packet, based on a match, can be as follows.

| | | Transport | Transport | |
|---|---|---|---|---|
| Destination | Source | layer | layer | |
| address | address | destination | protocol | Action |
| 100.200.300.40 | 40.50.60.70 | 1024 | UDP | Permit |
| 40.50.60.70 | 100.200.300.40 | 2056 | TCP | Deny |

Some examples can store rules 128 so that a memory address space can be used for both trie nodes and TCAM nodes and can store rules associated with nodes in TCAM or TCAM and memory based on available memory space in the TCAM and to attempt to reduce a number of nodes. One or more bits can indicate whether a rule associated with a node is stored in a TCAM or memory.

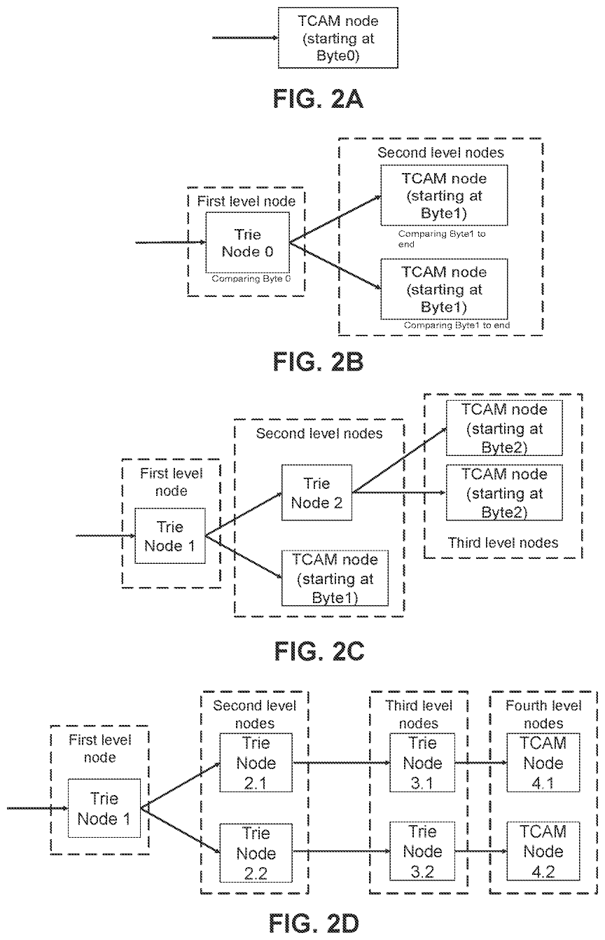

An example process to create rules 128 is as follows. A rule can be stored in a TCAM as first priority over other memory unless the TCAM is full (e.g., lacks memory capacity to store the entirety of the rule and associated metadata or unable to store the rule). Some of the storage space in the TCAM can be used as TCAM configuration (e.g. width, mask size). For example, for a first node, available TCAM can store an associated rule and action. Rules and actions associated with second and subsequent level nodes can be stored in the TCAM if space is available to store such rules and actions. If no space is available in the TCAM, as described with respect to FIG. 2B, rules and actions associated with the first node can be stored in memory and rules and actions associated with the last level node can be stored in the TCAM.

When no packet traffic is processed by network interface device 100, firmware 106, OS 156 and/or driver 158 can create rules 128 and enable the rules for performance by packet processors 104 or other circuitry of network interface device 100. However, when packet traffic is received or is to be transmitted by network interface device 100 and packet processors 104 can process packets according to a former rule set, firmware 106, OS 156 and/or driver 158 can create a second rules 128 and, during runtime, enable second rules 128 for performance by packet processors 104 or other circuitry.

For example, look up circuitry 108 can traverse nodes of a trie by performing character or bit matching against fields in rules 128 associated with nodes. Look up circuitry 108 can compare values in one or more packet header fields with rules in the trie sequentially until a rule is found that matches all relevant fields or a longest prefix match. For example, a longest prefix match may occur at a next to last level node as there may be no match with a rule at a last level node. An entry or rule can be associated with an appropriate mask and indicate how many bits of an input to match against the rule and a pointer to the next node if the current rule matches. The input can include one or more of: destination IP address, source IP address, protocol type, or other values in a packet header or payload. A TCAM can store rules associate with a lowest level node or single node for comparison. For no match with a rule in the trie, the packet can be dropped or an error indication issued to an administrator or controller.

A TCAM node can be a final node of the lookup as it provides the final lookup result and identifies an associated action. As the TCAM can store rules associated with a last node or sole node, TCAM may not store a pointer or offset from a base address associated with a next node or rule. The TCAM can store a pointer or offset from a base address to an action associated with a matched node to access the action from volatile memory, cache, or non-volatile memory.

By performing a final lookup using a TCAM using multi-bit matches against entries stored in the TCAM and reducing a number of nodes, various examples can potentially speed up lookup by reducing node traversal.

While examples are described with respect to a Trie, other data arrangements can be used. For example, a compressed trie with merged common branches, or a combination trie structure including sub-tries organized in a hierarchy can be used to store search strings and results.

Packet processors 104 and/or look up circuitry 108 can be implemented as one or more of: a processor core, field programmable gate array (FPGA), a processor that executes instructions, firmware, application specific integrated circuit (ASIC), or other circuitry.

Referring to network interface device 100, packet processors 104 can process data to be transmitted to server 150-0 to 150-A or received from server 150-0 to 150-A by performing one or more of: encryption, decryption, data compression, data decompression, data or device authentication, next hop determination, error value checking (e.g., cyclic redundancy check (CRC) or checksum), trust verification, or others.

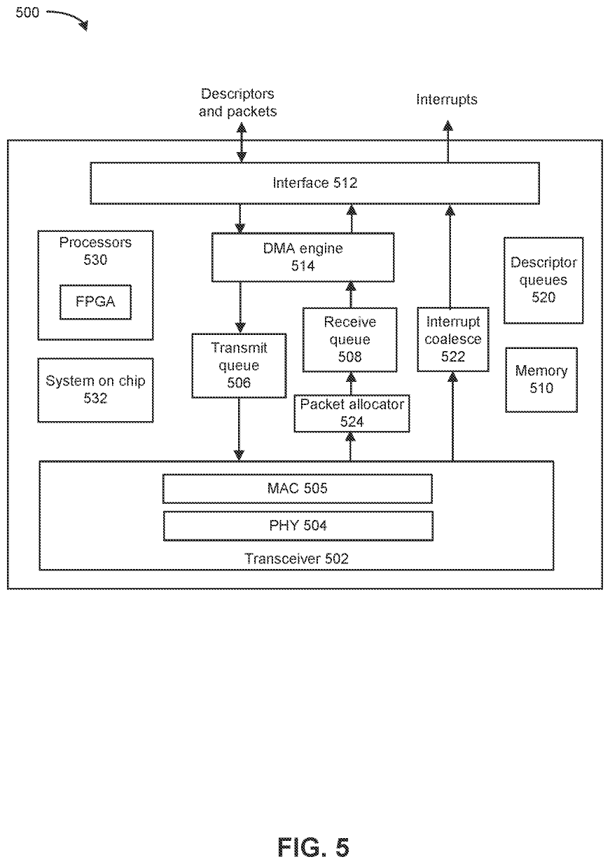

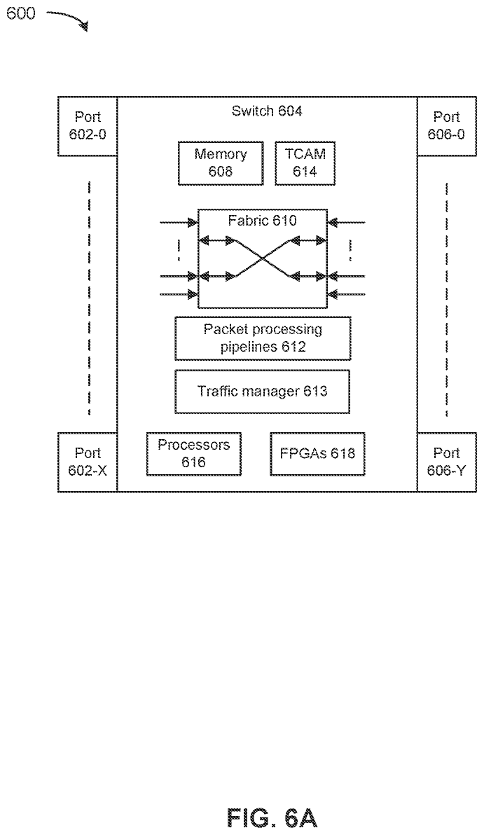

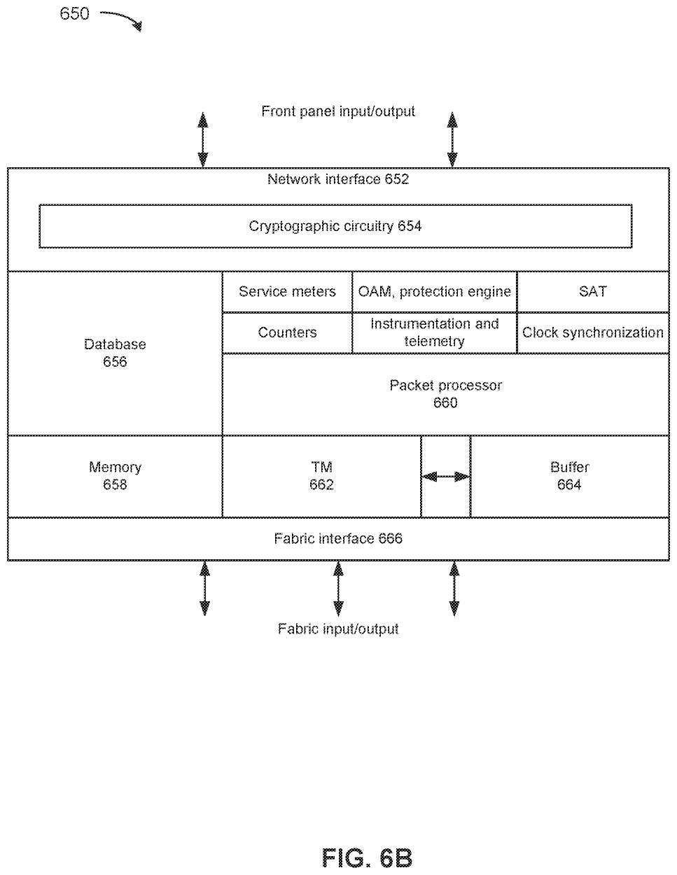

In some examples, network interface device 100 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An EPU can include a network interface device that utilizes processors and accelerators (e.g., digital signal processors (DSPs), signal processors, or wireless specific accelerators for Virtualized radio access networks (vRANs), cryptographic operations, compression/decompression, and so forth). A network interface device can include: one or more processors; one or more programmable packet processing pipelines; one or more accelerators; one or more application specific integrated circuits (ASICs); one or more field programmable gate arrays (FPGAs); one or more memory devices; one or more storage devices; or others. Other examples of network interface device 100 are described with respect to FIGS. 5, 6A, and/or 6B.

Communication circuitry 112 can provide communications with other devices over a network or fabric via one or more ports. Communication circuitry 112 may be configured to use any one or more communication technology (e.g., wired or wireless communications) and associated protocols (e.g., Ethernet, InfiniBand®, Bluetooth®, Wi-Fi®, 4G LTE, 5G, Ultra Ethernet, etc.) to perform such communication. Communication circuitry 112 can include one or more network hardware resources, such as ingress queues, egress queues, crossbars, shared memory switches, media access control (MAC), physical layer interface (PHY), Ethernet port logic, and other network hardware resources.

A packet may be used herein to refer to various formatted collections of bits that may be sent across a network, such as Ethernet frames, IP packets, TCP segments, UDP datagrams, etc. A flow can be a sequence of packets being transferred between two endpoints, generally representing a single session using a known protocol. Accordingly, a flow can be identified by a set of defined tuples or header field values and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 data plane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

One or more of servers 150-0 to 150-A, where A is an integer, can be coupled to network interface device 100 using a device interface 155 or network connection. For example, via interface 155, processors 152 and/or other circuitry can access network interface device 100 via communications consistent with Peripheral Component Interconnect Express (PCIe), Compute Express Link (CXL), Universal Chiplet Interconnect Express (UCIe), Single Root I/O Virtualization (SR-IOV), or Scalable Input/Output (I/O) Virtualization (S-IOV) virtual device. See, for example, Peripheral Component Interconnect Express (PCle) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. Single Root I/O Virtualization (SR-IOV) and Sharing specification, version 1.1, published Jan. 20, 2010 specifies hardware-assisted performance input/output (I/O) virtualization and sharing of devices. Intel® Scalable I/O Virtualization (S-IOV) permits configuration of a device to group its resources into multiple isolated Assignable Device Interfaces (ADIs). Direct Memory Access (DMA) transfers from/to an ADI are tagged with a unique Process Address Space identifier (PASID) number. An example technical specification for SIOV is Intel® Scalable I/O Virtualization Technical Specification, revision 1.0, June 2018, as well as earlier versions, later versions, and variations thereof.

While examples are described with respect to lookups for rules in a trie by a network interface device, other examples can include a device performing sorting of string keys, text search, web page searching, bioinformatics, or others. The device can include one or more of: a network interface, accelerator, storage controller, web server, ASIC, FPGA, processor, or other device or processor-executed software.

FIGS. 2A-2D depict examples of rule addition. FIG. 2A depicts an example of a single node. A first rule can be stored in a node in a TCAM and the node configured as a wide TCAM compare node. In other words, memory intended to be used in a trie node can be re-allocated to the TCAM. Rules and actions can be added as TCAM entries to the single node, until the rules cannot fit in the TCAM as the TCAM has insufficient memory capacity. In such case, as shown in FIG. 2B, the initial node is switched to a Trie node stored in memory and the two second or last level nodes of the Trie are stored in a TCAM for comparing the input except for the K bits already compared in the first Trie node. A pointer or memory address offset can identify a memory address in memory of actions instead of TCAM.

FIG. 2C depicts an example of adding two third or last level nodes to a trie. Rules and corresponding actions for third levels nodes can be stored in a TCAM, whereas rules and corresponding actions of first and second level nodes can be stored in volatile memory. A pointer or memory address offset can identify a memory address in memory of actions instead of TCAM.

FIG. 2D depicts an example of storing rules and actions associated with first, second, and third level nodes in a memory device and storing rules for a fourth level node in a TCAM. The actions for the rules associated with the fourth level node can be stored in the memory device.

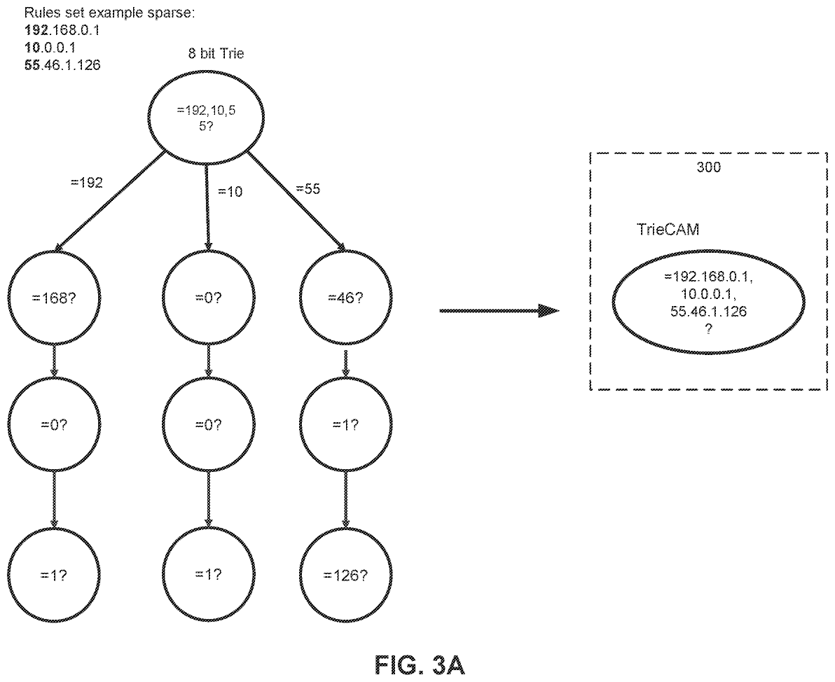

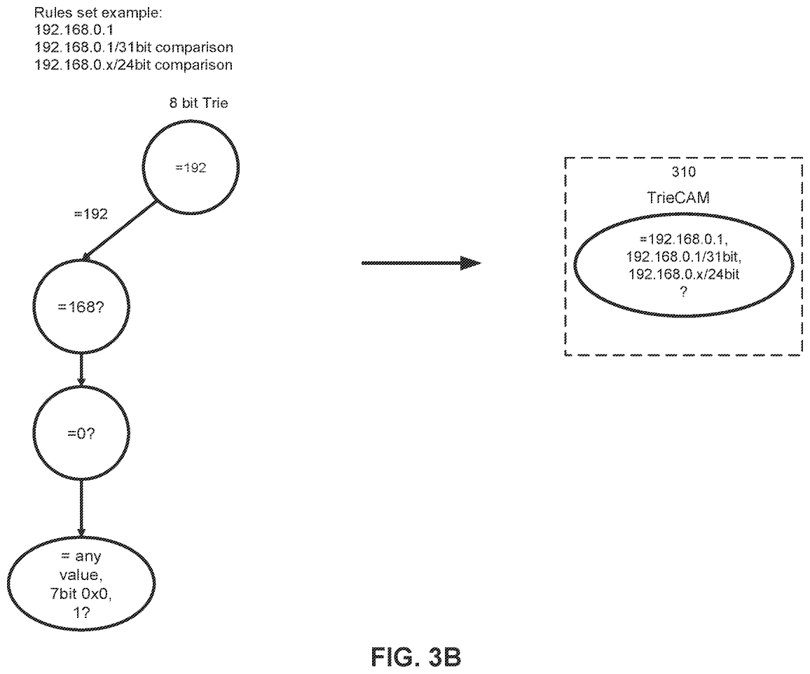

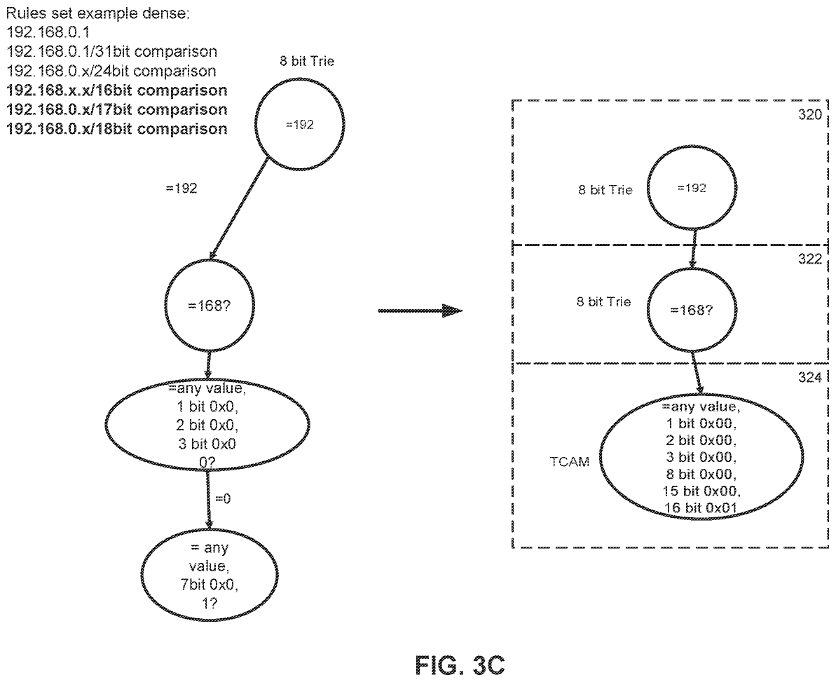

FIG. 3A depicts an example of representation of multiple rules of a trie for storage as multiple rules in a TCAM. For example, for a source IP address matching 192.168.0.1, 10.0.0.1, or 55.46.1.126, a particular rule can be performed. A TCAM can store rules and actions for three rules as a single node 300 instead of 10 nodes. In this example, a TCAM can store three rules and actions for a single node without surpassing a memory space limit and using less than 10 nodes for the same rule set.

FIG. 3B depicts an example of storing multiple rules of a trie as multiple rules in a TCAM. For example, for a source IP address matching 192.168.0.1, 192.168.0.1/31 bit comparison, or 192.168.0.x/24 bit comparison, one or more rule can be performed. A TCAM can store rules and actions for three rules as a single node 310 instead of 4 nodes. In this example, a TCAM can store data in node 310 that includes three rules and one or more corresponding actions for a single node without surpassing a memory space limit of the TCAM.

FIG. 3C depicts an example of storing multiple rules in first, second, and third levels nodes. For example, for a source IP address matching 192.168.0.1, 192.168.0.1/31 bit comparison, 192.168.0.x/24 bit comparison, 192.168.x.x/16 bit comparison, 192.168.0.x/17 bit comparison, or 192.168.0.x/18 bit comparison, one or more rules can be performed. In this example, a five level trie can be represented as trie node level 320 and trie node level 322 and a third level 324 of the trie stored in a TCAM.

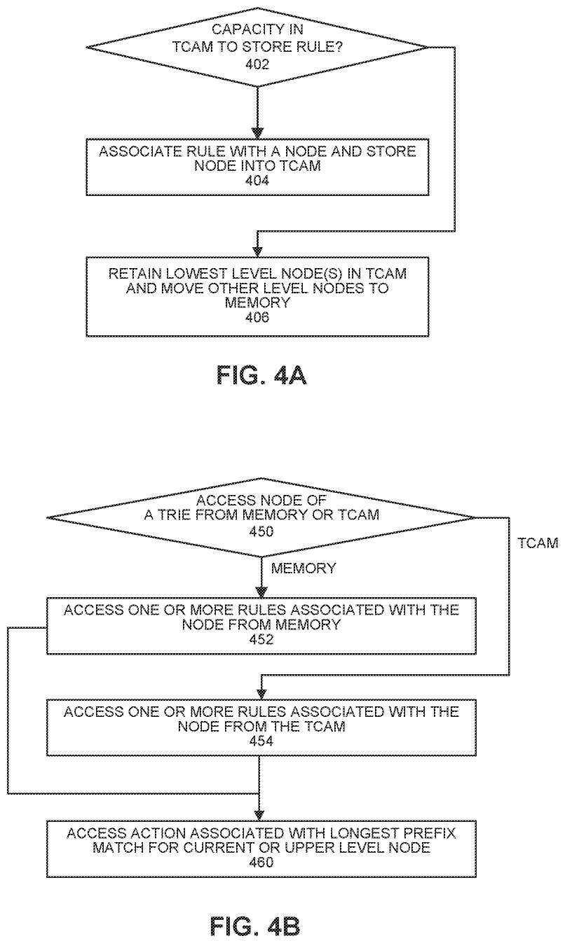

FIG. 4A depicts an example process. The process can be performed by an operating system, firmware, and/or driver for a device. The device can include one or more of: a network interface device, processor, PCIe or CXL connected device, and/or accelerator device. At 402, a determination can be made as to whether a TCAM has storage capacity to store a node of a trie with one or more rules and one or more corresponding actions to be performed. Based on the TCAM having storage capacity to store the node, the process can proceed to 404, to store the node into the TCAM.

Based on the TCAM not having storage capacity to store the rule within the node, the process can proceed to 406, to retain storage of one or more lowest level nodes in the TCAM, if present, and to move upper level nodes for storage in a memory. Storage nodes can include storage of one or more of: a key to match against, a rule, a filter, a mask, a pointer or offset to a memory address of an action, or others.

FIG. 4B depicts an example process. The process can be performed by a lookup circuitry and/or processor of a device. The device can include one or more of: a network interface device, processor, PCIe or CXL connected device, and/or accelerator device. At 450, for a trie traversal to determine a longest prefix match and identify a rule to apply to a packet or other data, a node of a trie can be identified based on a match of a portion of an input. For example, a pointer to an address can identify a location of the data. The rule to apply to a packet or other data can be stored in a memory address associated with a memory or a TCAM. At 452, based on the rule being stored in the memory, the rule can be accessed from the memory. At 454, based on the rule being stored in the TCAM, the rule can be accessed from the TCAM. At 460, an action associated with a longest prefix match with the input or most number of matching bits, can be accessed and applied. For example, the action may be associated with a current node level or an upper node level. The rule can be associated with a pointer and stored in memory or the TCAM.

FIG. 5 depicts an example network interface device. Some examples of network interface 500 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable circuitries or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 530, transmit queue 506, receive queue 508, memory 510, and host interface 512, and DMA engine 514. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 504 and media access control (MAC) circuitry 505. PHY circuitry 504 can include encoding and decoding circuitry (not shown) to encode and decode data packets according to applicable physical layer specifications or standards. MAC circuitry 505 can be configured to perform MAC address filtering on received packets, process MAC headers of received packets by verifying data integrity, remove preambles and padding, and provide packet content for processing by higher layers. MAC circuitry 505 can be configured to assemble data to be transmitted into packets, that include destination and source addresses along with network control information and error detection hash values.

Processors 530 can be one or more of: combination of: a processor, core, graphics processing unit (GPU), field programmable gate array (FPGA), application specific integrated circuit (ASIC), or other programmable hardware device that allow programming of network interface 500. For example, a “smart network interface” or SmartNIC can provide packet processing capabilities in the network interface using processors 530.

Processors 530 can include a programmable processing pipeline or offload circuitries that is programmable by P4, Software for Open Networking in the Cloud (SONIC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be utilized for packet processing or packet modification. Ternary content-addressable memory (TCAM) can be used for parallel match-action or look-up operations on packet header content. Various examples of processors 530 can perform a lookup of nodes and determine whether there is a match for the rule and access and perform an action, as described herein.

Packet allocator 524 can provide distribution of received packets for processing by multiple CPUs or cores using receive side scaling (RSS). When packet allocator 524 uses RSS, packet allocator 524 can calculate a hash or make another determination based on contents of a received packet to determine which CPU or core is to process a packet.

Interrupt coalesce 522 can perform interrupt moderation whereby interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 514 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be volatile and/or non-volatile memory device and can store any queue or instructions used to program network interface 500. Transmit traffic manager can schedule transmission of packets from transmit queue 506. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Bus interface 512 can provide an interface with host device (not depicted). For example, bus interface 512 can be compatible with or based at least in part on PCI, PCIe, PCI-x, Serial ATA, and/or USB (although other interconnection standards may be used), or proprietary variations thereof.

FIG. 6A depicts an example switch. Various examples can be used in or with the switch to perform a lookup of nodes and determine whether there is a match for the rule and access and perform an action, as described herein. Switch 604 can route packets or frames of any format or in accordance with any specification from any port 602-0 to 602-X to any of ports 606-0 to 606-Y (or vice versa). Any of ports 602-0 to 602-X can be connected to a network of one or more interconnected devices. Similarly, any of ports 606-0 to 606-Y can be connected to a network of one or more interconnected devices.

In some examples, switch fabric 610 can provide routing of packets from one or more ingress ports for processing prior to egress from switch 604. Switch fabric 610 can be implemented as one or more multi-hop topologies, where example topologies include torus, butterflies, buffered multi-stage, etc., or shared memory switch fabric (SMSF), among other implementations. SMSF can be any switch fabric connected to ingress ports and egress ports in the switch, where ingress subsystems write (store) packet segments into the fabric's memory, while the egress subsystems read (fetch) packet segments from the fabric's memory.

Memory 608 can be configured to store packets received at ports prior to egress from one or more ports. Packet processing pipelines 612 can include ingress and egress packet processing circuitry to respectively process ingressed packets and packets to be egressed. Packet processing pipelines 612 can determine which port to transfer packets or frames to using a table that maps packet characteristics with an associated output port. Packet processing pipelines 612 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing pipelines 612 can implement access control list (ACL) or packet drops due to queue overflow. Packet processing pipelines 612 can be configured to perform a lookup of nodes and determine whether there is a match for the rule and access and perform an action, as described herein. Configuration of operation of packet processing pipelines 612, including its data plane, can be programmed using P4, C, Python, Broadcom Network Programming Language (NPL), or x86 compatible executable binaries or other executable binaries. Processors 616 and FPGAs 618 can be utilized for packet processing or modification.

Traffic manager 613 can perform hierarchical scheduling and transmit rate shaping and metering of packet transmissions from one or more packet queues. Traffic manager 613 can perform congestion management such as flow control, congestion notification message (CNM) generation and reception, priority flow control (PFC), and others.

FIG. 6B depicts an example switch chip. Various examples can be used in or with the switch to perform a lookup of nodes and determine whether there is a match for the rule and access and perform an action, as described herein. Switch 650 can include a network interface 652 that can provide an Ethernet consistent interface. Network interface 652 can support 25 GbE, 50 GbE, 100 GbE, 200 GbE, 400 GbE Ethernet port interfaces. Cryptographic circuitry 654 can perform at least Media Access Control security (MACsec) or Internet Protocol Security (IPSec) decryption for received packets or encryption for packets to be transmitted.

Various circuitry can perform one or more of: service metering, packet counting, operations, administration, and management (OAM), protection engine, instrumentation and telemetry, and clock synchronization (e.g., based on IEEE 1588).

Database 656 can store a device's profile to configure operations of switch 650. Memory 658 can include High Bandwidth Memory (HBM) for packet buffering. Packet processor 660 can perform one or more of: decision of next hop in connection with packet forwarding, packet counting, access-list operations, bridging, routing, Multiprotocol Label Switching (MPLS), virtual private LAN service (VPLS), L2VPNs, L3VPNs, OAM, Data Center Tunneling Encapsulations (e.g., VXLAN and NV-GRE), or others. Packet processor 660 can include one or more FPGAs. Buffer 664 can store one or more packets. Traffic manager (TM) 662 can provide per-subscriber bandwidth guarantees in accordance with service level agreements (SLAs) as well as performing hierarchical quality of service (QOS). Fabric interface 666 can include a serializer/de-serializer (SerDes) and provide an interface to a switch fabric.

Operations of components of switches of examples of devices of FIGS. 5, 6A, and/or 6B can be combined and components of the switches of examples of FIGS. 5, 6A, and/or 6B can be included in other examples of switches of examples of FIGS. 5, 6A, and/or 6B. For example, components of examples of switches of FIGS. 5, 6A, and/or 6B can be implemented in a switch system on chip (SoC) that includes at least one interface to other circuitry in a switch system. A switch SoC can be coupled to other devices in a switch system such as ingress or egress ports, memory devices, or host interface circuitry.

FIG. 7 depicts a system. In some examples, circuitry of network interface 750 can be configured to perform a lookup of nodes and determine whether there is a match for the rule and access and perform an action, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia® Broadcom®, Texas Instruments®, among others.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), data processing unit (DPU), EPU, or others.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), RoCE v2, Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 700 can be implemented using interconnected compute platforms of processors, memories, storages, network interfaces, and other components. High speed interconnects can be used such as PCle, CXL, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples and includes at least one non-transitory computer-readable medium comprising instructions stored thereon, that if executed by one or more processors, cause the one or more processors to: access rules for a network interface device to apply to packets by: including a first rule to apply to the packets in a ternary content-addressable memory (TCAM); based on capability for the TCAM to store a second rule to apply to the packets, storing the second rule in the TCAM; and based on incapability of the TCAM to store the first rule and the second rule: storing the first rule in a random access memory (RAM) and storing the second rule in the TCAM, wherein the first rule is associated with a node of a trie and traversal of the trie identifies a rule based on longest prefix match (LPM).

Example 2 includes one or more examples, wherein the first rule is associated with a first portion of a value in a field of a packet of the packets and the second rule is associated with a second portion of the value.

Example 3 includes one or more examples, wherein the value comprises an Internet Protocol (IP) address.

Example 4 includes one or more examples, wherein: the first rule is associated with a first match value and a first action and the second rule is associated with a second match value and a second action.

Example 5 includes one or more examples, wherein: the capability of the TCAM to store the second rule to apply to the packets comprises the TCAM having memory space to store the second rule.

Example 6 includes one or more examples, and includes instructions stored thereon, that if executed by one or more processors, cause the one or more processors to: for a first packet, based on a match to the first rule, performing an exact match with the second rule and based on the match with the second rule, cause the network interface device to perform an action associated with the second rule.

Example 7 includes one or more examples, wherein: the action associated with the second rule comprises one or more of: forward, drop, modify, or send to controller.

Example 8 includes one or more examples, wherein: a Linux operating system (OS) or driver performs the storing the first rule and the second rule.

Example 9 includes one or more examples, and includes a method comprising: configuring a network interface device to perform longest prefix match (LPM) of rules associated with nodes to identify an action to perform on a packet, wherein the rules are stored in a memory and ternary content-addressable memory (TCAM) based on available memory capacity of the TCAM.

Example 10 includes one or more examples, wherein: based on rules associated with a first node being within a size of the available memory capacity, the rules associated with the first node are retrieved from the TCAM.

Example 11 includes one or more examples, wherein: based on rules associated with a first node not being within a size of the available memory capacity, at least one rule of the first node is stored in the TCAM and at least one rule of the first node is stored in the memory.

Example 12 includes one or more examples, wherein: based on the rules associated with a first node and a second node not being within a size of the available memory capacity, at least one rule of the first node is moved from the TCAM to the memory and at least one rule of the second node is stored in the memory.

Example 13 includes one or more examples, wherein the nodes are associated with a trie and comprising: traversing the nodes by performing LPM of an input with the rules.

Example 14 includes one or more examples, wherein the input comprises a value in a field of a packet.

Example 15 includes one or more examples, and includes performing an action associated with a rule that matches a longest prefix of the input.

Example 16 includes one or more examples, and includes a process of making a network forwarding device comprising: connecting a switch chip to multiple ports; connecting a switch fabric to the switch chip; and connecting a ternary content-addressable memory (TCAM) to the switch chip, wherein the network forwarding device is configurable to perform longest prefix match (LPM) of trie nodes stored in the memory and the TCAM.

Example 17 includes one or more examples, and includes storing rules associated with a node in the TCAM based on available memory in the TCAM.

Example 18 includes one or more examples, and includes storing rules associated with a node in a memory based on unavailable memory in the TCAM.

Example 19 includes one or more examples, and includes based on unavailable memory in the TCAM, moving a rule from the TCAM to the memory and storing a second rule in the TCAM.

Example 20 includes one or more examples, wherein the memory comprises static random access memory (SRAM).

What is claimed is:

1. At least one non-transitory computer-readable medium comprising instructions stored thereon, that if executed by one or more processors, cause the one or more processors to:
access rules for a network interface device to apply to packets by:
including a first rule to apply to the packets in a ternary content-addressable memory (TCAM);
based on capability for the TCAM to store a second rule to apply to the packets, storing the second rule in the TCAM; and
based on incapability of the TCAM to store the first rule and the second rule:
storing the first rule in a random access memory (RAM) and
storing the second rule in the TCAM, wherein the first rule is associated with a node of a trie and traversal of the trie identifies a rule based on longest prefix match (LPM).

2. The computer-readable medium of claim 1, wherein the first rule is associated with a first portion of a value in a field of a packet of the packets and the second rule is associated with a second portion of the value.

3. The computer-readable medium of claim 2, wherein the value comprises an Internet Protocol (IP) address.

4. The computer-readable medium of claim 1, wherein:
the first rule is associated with a first match value and a first action and
the second rule is associated with a second match value and a second action.

5. The computer-readable medium of claim 1, wherein:
the capability of the TCAM to store the second rule to apply to the packets comprises the TCAM having memory space to store the second rule.

6. The computer-readable medium of claim 1, comprising instructions stored thereon, that if executed by one or more processors, cause the one or more processors to:
for a first packet, based on a match to the first rule, performing an exact match with the second rule and
based on the match with the second rule, cause the network interface device to perform an action associated with the second rule.

7. The computer-readable medium of claim 6, wherein:
the action associated with the second rule comprises one or more of: forward, drop, modify, or send to controller.

8. The computer-readable medium of claim 6, wherein:
a Linux operating system (OS) or driver performs the storing the first rule and the second rule.

9. A method comprising:
configuring a network interface device to perform longest prefix match (LPM) of rules associated with nodes to identify an action to perform on a packet, wherein the rules are stored in a memory and ternary content-addressable memory (TCAM) based on available memory capacity of the TCAM.

10. The method of claim 9, wherein:
based on rules associated with a first node being within a size of the available memory capacity, the rules associated with the first node are retrieved from the TCAM.

11. The method of claim 9, wherein:
based on rules associated with a first node not being within a size of the available memory capacity, at least one rule of the first node is stored in the TCAM and at least one rule of the first node is stored in the memory.

12. The method of claim 9, wherein:
based on the rules associated with a first node and a second node not being within a size of the available memory capacity, at least one rule of the first node is moved from the TCAM to the memory and at least one rule of the second node is stored in the memory.

13. The method of claim 9, wherein the nodes are associated with a trie and comprising:
traversing the nodes by performing LPM of an input with the rules.

14. The method of claim 13, wherein the input comprises a value in a field of a packet.

15. The method of claim 13, comprising:
performing an action associated with a rule that matches a longest prefix of the input.

16. A process of making a network forwarding device comprising:
connecting a switch chip to multiple ports;
connecting a switch fabric to the switch chip; and
connecting a ternary content-addressable memory (TCAM) to the switch chip, wherein the network forwarding device is configurable to perform longest prefix match (LPM) of trie nodes stored in the memory and the TCAM.

17. The process of claim 16, comprising:
storing rules associated with a node in the TCAM based on available memory in the TCAM.

18. The process of claim 16, comprising:
storing rules associated with a node in a memory based on unavailable memory in the TCAM.

19. The process of claim 16, comprising:
based on unavailable memory in the TCAM, moving a rule from the TCAM to the memory and storing a second rule in the TCAM.

20. The process of claim 16, wherein the memory comprises static random access memory (SRAM).
